(19) United States
(12) Patent Application Publication
(10) Pub. No.: US 2010/0039328 A1
(43) Pub. Date: Feb. 18, 2010

(54) ANNULAR ANTENNA

(75) Inventors: Tsung-Wen Chiu, Taipei County (TW); SHENG-CHIH LIN, Taipei County (TW); WEN-HIS LEE, Taipei County (TW); Yi-Wei Tseng, Taipei County (TW); Fu-Ren Hsiao, Taipei County (TW)

Correspondence Address: SCHMEISER OLSEN & WATTS, 18 E UNIVERSITY DRIVE, SUITE # 101, MESA, AZ, 85201, US

(73) Assignee: ADVANCED CONNECTEK INC., Taipei County (TW)

(21) Appl. No.: 12/246,016

(22) Filed: Oct. 6, 2008

(30) Foreign Application Priority Data
Aug. 15, 2008 (TW) 097131261

(51) Int. Cl. H01Q 1/38

(52) U.S. Cl. 343/700 MS

(57) ABSTRACT

An annular antenna is composed of a ground plane, a short-circuit conductor, a radiation conductor and a parasitic conductor. The radiation conductor has a connection member and a feeder member. Two ends of the short-circuit member are respectively connected to the ground plane and connection member. The feeder member is close to the ground plane and has a notch. The short-circuit conductor and radiation conductor run along the ground plane defining an in-annular area. The radiation conductor has a first coupling edge beside the in-annular area. The parasitic conductor is inside the in-annular area with one end coupled to the ground plane and a second coupling edge along the first coupling edge. The first and second coupling edges have a gap therebetween. The radiation and parasitic conductors respectively excite low-frequency and high-frequency resonant modes. The annular antenna covers multiple frequency bands, has UWB features and simplified structure and favors mass-production.

### BACKGROUND OF THE INVENTION

1. Field of the Invention

The present invention relates to an annular antenna, particularly to an antenna system, which integrates a low-frequency resonant mode and a high-frequency resonant mode, covers several operational frequency bands and has UWB features.

2. Description of the Related Art

With the tendency of miniaturizing antennae, micro-antenna design is growing more and more important in related fields. Some types of antennae are usually used in micro-antenna design, including the planar inverted-F antenna (PIFA), the monopole antenna and the dipole antenna. To reduce volume, radiation conductors are usually greatly modified in structure and appearance. For example, they may be designed to have a shape of a circle, an oval, a ring, a rectangle, or a triangle, etc. The visible portion of an antenna has been reduced from original 5-10 cm to below 3 cm. Now, an antenna may even integrate with a circuit board and can receive signals of different frequency bands. For example, the Wi-Fi module of a mobile phone may share a common antenna with a Bluetooth module. In fact, an integration antenna design usually incorporates several wireless standards of the adjacent frequency bands.

The conventional dual-band antennae usually integrate two types of antennae or more. For example, a U.S. Pat. No. 6,204,819 disclosed a dual-band antenna structure, which integrates a planar inverted-F antenna and an annular antenna, and which switches between two antennae to receive different feed-in signals via the operation of a switch device. However, the prior-art antenna is bulky and hard to layout. Further, it needs a chip to switch the operational frequencies. Therefore, the prior-art antenna has a complicated circuit and a high fabrication cost.

FIG. 1 shows a front view of a “Dual-Band Antenna” disclosed by a U.S. Pat. No. 7,180,463. The prior-art antenna is printed on a substrate 11 and comprises a signal feed-in element 12, an impedance element 13, a first transmitting element 14, a first feed-in point 141, a second transmitting element 15, a second feed-in point 151, and a ground point 17. The signal feed-in element 12 is electrically connected to the first feed-in point 141 and the second feed-in point 151, and respectively provides ¼-wavelength resonant cavities for them in cooperation with the ground point 17. The first transmitting element 14 is connected to the signal feed-in element 12 via the first feed-in point 141 and used to transmit a high frequency signal. The second transmitting element 15 is connected to the signal feed-in element 12 via the second feed-in point 151 and used to transmit a low frequency signal.

FIG. 2 is a diagram showing the measurement results of the return loss of the “Dual-Band Antenna” disclosed by the U.S. Pat. No. 7,180,463. From FIG. 2, it is known that the mean return loss of the system is below −10 db at the system operational frequency bands of 2.4-2.5 GHz and 4.3-6 GHz. Therefore, the operational frequency bands of the system completely cover the operational frequency bands of IEEE802.11a and 802.11b.

In the abovementioned “Dual-Band Antenna”, the sending end of the second transmitting element 15 is bent into an “L” shape to increase the area of the sending end and increase the transmitting bandwidth. However, such a design increases the length and volume of the antenna conductor. For modulating the impedance matching of the first transmitting element 14, a support element 16 is arranged opposite to the second transmitting element 15 across the first transmitting element 14. The support element 16 and the first transmitting element 14 are parallel to each other and have a gap therebetween to form a capacitive load. However, such a design results in a complicated antenna structure. Further, the support element 16 is hard to be positioned precisely.

### SUMMARY OF THE INVENTION

One objective of the present invention is to provide an annular antenna, which uses a radiation conductor to excite a low-frequency resonant mode and uses a parasitic conductor to excite a high-frequency resonant mode, and which covers several operation frequency bands and has a UWB (Ultra Wide Band) feature, and which integrates a planar inverse-F antenna (PIFA) and an annular antenna and achieves antenna miniaturization without compromising UWB features, whereby the problems of the conventional integration antennae are overcome.

Another objective of the present invention is to provide an annular antenna, wherein a ground plane, a short-circuit conductor, and a radiation conductor jointly define an in-annular area, and a parasitic conductor is arranged in the in-annular area, whereby the annular antenna of the present invention has UWB features, and the layout space of the antenna system is greatly reduced, and whereby the annular antenna of the present invention is easy-to-layout and easy-to-assemble for various electronic products and facilitates mass production.

To achieve the abovementioned objectives, the present invention proposes an annular antenna comprising a ground plane, a short-circuit conductor, a radiation conductor, and a parasitic conductor. The radiation conductor has a connection member and a feeder member. One end of the short-circuit member is connected to the ground plane, and the other end of the short-circuit member is connected to the connection member. The feeder member is close to the ground plane and formed to have a notch. The short-circuit conductor and the radiation conductor run along one side of the ground plane to define an in-annular area. The radiation conductor has a first coupling edge adjacent to the in-annular area. The parasitic conductor is arranged inside the in-annular area, and the parasitic conductor has a second coupling edge arranged along the contour of the first coupling edge. One end of the parasitic conductor is connected to the ground plane. The first coupling edge and the second coupling edge have a gap therebetween.

In the present invention, the radiation conductor excites a low-frequency resonant mode of the antenna system. Adjusting the lengths of the radiation conductor and the short-circuit conductor can control the operational frequency of the low-frequency resonant mode. Slightly modulating the ratio of the widths of the radiation conductor and the short-circuit conductor can improve the impedance matching of the low-frequency resonant mode. The parasitic conductor arranged inside the in-annular area excites a high-frequency resonant mode. Adjusting the length of the parasitic conductor can control the operational frequency of the high-frequency resonant mode. Adjusting the gap of the first coupling edge and the second coupling edge can improve the impedance matching of the high-frequency resonant mode. In the present invention, the low-frequency and high-frequency resonant modes are integrated into a UWB mode. Thereby, the annular antenna of the present invention covers several operation frequency bands and has UWB features. The present invention incorporates the design concepts of a planar inverted-F antenna and an annular antenna and achieves antenna miniaturization without compromising UWB features. Further, the simple configuration of the short-circuit conductor, the radiation conductor and the parasitic conductor reduces the layout volume of the antenna. Therefore, the present invention is easy-to-layout and easy-to-assemble for various electronic devices and has a lower fabrication cost.

Below, the embodiments are described in detail to make easily understood the technical contents of the present invention.

### BRIEF DESCRIPTION OF THE DRAWINGS

FIG. 1 is a front view of a “Dual-B and Antenna” disclosed by a U.S. Pat. No. 7,180,463;

FIG. 2 is a diagram showing the measurement results of the return loss of the “Dual-Band Antenna” disclosed by the U.S. Pat. No. 7,180,463;

FIG. 3 is a front view of an annular antenna according to a first embodiment of the present invention;

FIG. 4 is a diagram schematically showing a second embodiment of the present invention, wherein the radiation conductor and the parasitic conductor are varied;

FIG. 5 is a diagram showing the measurement results of the voltage standing wave ratio of the antenna system of the first embodiment; and

FIG. 6 is a perspective view showing that the first embodiment of the present invention is applied to a portable computer.

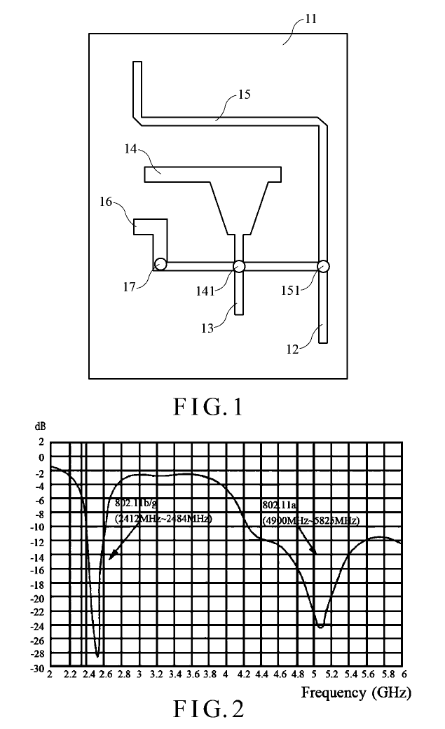

### DETAILED DESCRIPTION OF THE INVENTION

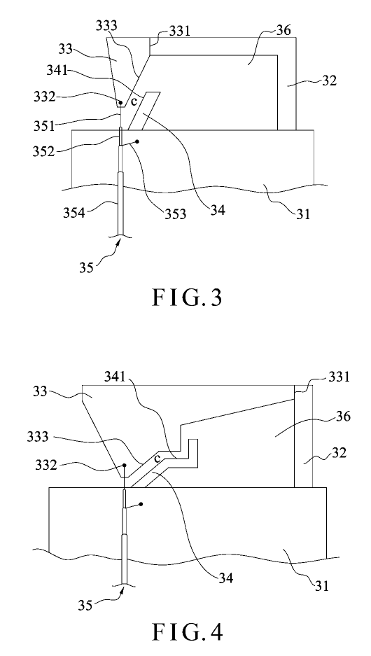

FIG. 3 shows a front view of a first embodiment of the present invention. The annular antenna of the present invention comprises a ground plane 31, a short-circuit conductor 32, a radiation conductor 33, a parasitic conductor 34 and a feeder cable 35. The radiation conductor 33 has a connection member 331 and a feeder member 332.

One end of the short-circuit member 32 is connected to the ground plane 31, and the other end of the short-circuit member 32 is connected to the connection member 331. The feeder member 332 is close to the ground plane 31 and formed to have a notch. The short-circuit conductor 32 and the radiation conductor 33 run along one side of the ground plane 31. Thus, an in-annular area 36 is defined by the short-circuit conductor 32, the radiation conductor 33 and the ground plane 31. The radiation conductor 33 has a first coupling edge 333 adjacent to the in-annular area 36. The parasitic conductor 34 is arranged inside the in-annular area 36, and the parasitic conductor 34 has a second coupling edge 341 arranged along the contour of the first coupling edge 333. The first coupling edge 333 and the second coupling edge 341 have a gap C therebetween to generate a capacitive coupling effect and increase the radiation transmission efficiency of the parasitic conductor 34. The feeder cable 35 has a central conduction wire 351, an insulation layer 352, an outer conduction wire 353 and a coating layer 354 in sequence from the center. The central conduction wire 351 is connected to feeder member 332 and transfers the high-frequency signal of the feeder cable 35 to the feeder member 332. The outer conduction wire 353 is connected to the ground plane 31.

The short-circuit conductor 32 has a ground plane-bordering rectangular portion and a radiation conductor-bordering rectangular portion. The ground plane-bordering rectangular portion has a length of about 10 mm and a width of about 2 mm. The radiation conductor-bordering rectangular portion has a length of about 13 mm and a width of about 2 mm. The radiation conductor 33 has a trapezoid shape with an upper side of about 6 mm, a lower side of about 0.5 mm, a height of about 7 mm, and a slanted side of about 8 mm. The parasitic conductor 34 has a parallelogram shape with a height of about 4 mm, and an upper side and a lower side both of about 1 mm.

In this embodiment, the ground plane 31, the short-circuit conductor 32 and the radiation conductor 33 form an annular conductor structure having a lying U shape, which contains the in-annular area 36. The radiation conductor 33 excites a low-frequency resonant mode of the antenna system. Adjusting the lengths of the radiation conductor 33 and the short-circuit conductor 32 can control the operational frequency of the low-frequency resonant mode. Slightly modulating the ratio of the widths of the radiation conductor 33 and the short-circuit conductor 32 can improve the impedance matching of the low-frequency resonant mode. The parasitic conductor 34 arranged inside the in-annular area 36 excites a high-frequency resonant mode. Adjusting the length of the parasitic conductor 34 can control the operational frequency of the high-frequency resonant mode. Adjusting the gap C of the first coupling edge 333 and the second coupling edge 341 can improve the impedance matching of the high-frequency resonant mode. In the present invention, the low-frequency and high-frequency resonant modes are integrated into an UWB (Ultra Wide Band) mode. Thereby, the annular antenna of the present invention covers several operation frequency bands and has UWB features. Thus, the present invention achieves a UWB antenna system and the miniaturization of the antenna system. Contrarily to the conventional wireless communication technology that continuously generates electromagnetic waves, the UWB antenna system of the present invention does not generate electromagnetic waves except it transmits data. Therefore, the UWB system of the present invention not only can transmit massive audio/video data but also consumes less power.

Referring to FIG. 4, a diagram schematically shows a second embodiment of the present invention, wherein the radiation conductor and the parasitic conductor are varied. The second embodiment is similar to the first embodiment except the parasitic conductor 34 has a serpentine or stepped shape in the second embodiment. The radiation conductor 33 maintains a trapezoid shape, but the first coupling edge 333 thereof, which is corresponding to the second coupling edge 341, has a serpentine or stepped shape. The short-circuit conductor 32 has two pieces of rectangular portions in the first embodiment, but the two pieces of rectangular portions are reduced into a single piece of rectangular conductor in the second embodiment. In the second embodiment, one end of the short-circuit member 32 is also connected to the ground plane 31, and the other end of the short-circuit 32 is also connected to the connection member 331. Similarly to the first embodiment, the ground plane 31, the short-circuit conductor 32 and the radiation conductor 33 define the in-annular area 36, and the parasitic conductor 34 is arranged inside the in-annular area 36. In the second embodiment, the generation of the low-frequency and high-frequency resonant modes and the control of the operational frequency bands and the impedance matching are similar to those of the first embodiment.

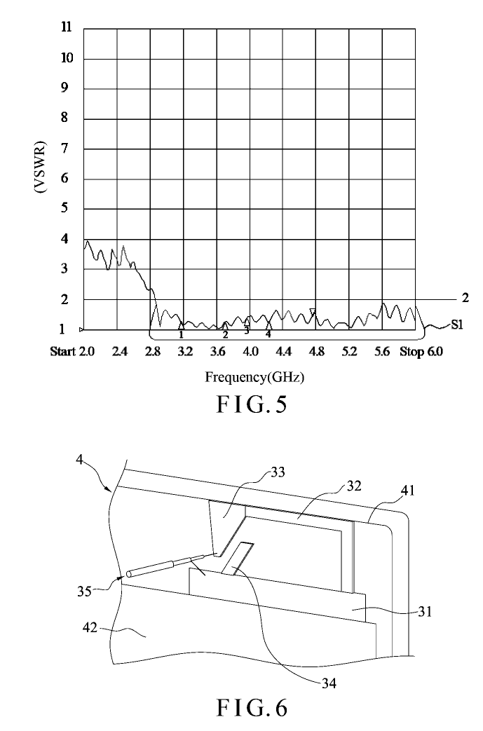

Referring to FIG. 5, a diagram shows the measurement results of the voltage standing wave ratio of the antenna system of the first embodiment. When a low-frequency and high-frequency operational bandwidth S1 is defined by a voltage standing wave ratio of 2, the operational frequency band of the antenna of the present invention ranges from 2.9 GHz to 6 GHz, which covers the frequency bands of the following systems:

(1)UWB (3.1 GHz-4.9 GHz)

(2)WLAN802.11a (4.9 GHz-5.9 GHz)

The measurement results show that the present invention covers the frequency band of from 2.9 GHz to 6 GHz and indeed possesses UWB features. Therefore, the present invention not only has a wider operation frequency band than a conventional dual-frequency antenna but also has a simplified structure. Hence, the present invention achieves a multi-frequency antenna system and the miniaturization thereof.

Referring to FIG. 6, a perspective view shows that the first embodiment of the present invention is applied to a portable computer. The annular antenna of the present invention is arranged near the edge of a chassis 41 of a portable computer 4. A tin foil is used as the ground plane 31 and stuck to the chassis 41, and a screen 42 is arranged inside the chassis 41. The chassis 41 functions as the ground plane of the entire annular antenna; the tin foil transfers the ground signals to the chassis 41. In the application of the present invention, the configuration of the short-circuit conductor 32, the radiation conductor 33 and the parasitic conductor 34 simplifies the antenna structure and reduces the antenna volume. Therefore, the annular antenna of the present invention is easy-to-layout and easy-to-assemble for various electronic devices and facilitates the mass production of the electronic devices using the present invention.

From the above description, it is known that the present invention possesses utility, novelty and non-obviousness and meets the conditions for a patent. However, it is to be noted that the embodiments described above are only to exemplify the present invention but not to limit the scope of the present invention. Therefore, any equivalent modification or variation according to the spirit of the present invention is to be also included within the scope of the present invention.

What is claimed is:

1. A annular antenna comprising
a ground plane;
a short-circuit conductor with one end thereof coupled to said ground plane;
a radiation conductor including a connection member coupled to another end of said short-circuit conductor and a feeder member close to said ground plane and formed to have a notch, wherein said short-circuit conductor and said radiation conductor run along one side of said ground plane to define an in-annular area, and wherein said radiation conductor has a first coupling edge adjacent to said in-annular area; and
a parasitic conductor arranged inside said in-annular area, having one side thereof coupled to said ground plane, and having a second coupling edge corresponding to a contour of said first coupling edge of said radiation conductor, wherein said first coupling edge and said second coupling edge have a gap therebetween.

2. The annular antenna according to claim 1 further comprising a feeder cable including
a central conduction wire connected to said feeder member; and
an outer conduction wire connected to said ground plane.

3. The annular antenna according to claim 1, wherein said short-circuit conductor and said radiation conductor jointly form an annular conductor structure having a lying U shape.

4. The annular antenna according to claim 1, wherein said parasitic conductor has a parallelogram shape.

5. The annular antenna according to claim 1, wherein said parasitic conductor has a stepped shape.

6. The annular antenna according to claim 1, wherein said parasitic conductor is arranged in near said notch.
